(19) United States
(12) Patent Application Publication
(10) Pub. No.: US 2023/0219732 A1
(43) Pub. Date: Jul. 13, 2023

(54) A PROCESS FOR PRODUCING A PACKAGING MATERIAL

(71) Applicant: Stora Enso OYJ, Helsinki (FI)

(72) Inventors: Chris Bonnerup, Floda (SE); Magnus Ekberg, Fors (SE); Kaj Backfolk, Villmanstrand (FI)

(73) Assignee: Stora Enso OYJ, Helsinki (FI)

(21) Appl. No.: 17/999,062

(22) PCT Filed: May 18, 2021
(86) PCT No.: PCT/IB2021/054254

§ 371 Date: Nov. 17, 2022

(30) Foreign Application Priority Data
May 18, 2020 (SE) 2050575-6

(51) Int. Cl. B65D 65/42; D21H 19/60; D21H 19/22; D21H 25/06

(52) U.S. Cl. CPC B65D 65/42; D21H 19/60; D21H 19/22; D21H 25/06

(57) ABSTRACT

The invention discloses a method for producing a packaging material and a packaging material suitable for packaging of food and/or liquid. In the method of the invention a first barrier layer, and an optional second barrier layer, is applied on a first side of a paperboard web. The thereby formed barrier coated web is at least partly dried in a first drying step, whereupon an extruded layer is applied onto the partly dried barrier coated web in a second coating step. In accordance with the invention, the first and second coating steps are applied integrated within the same coating line. The application of a first barrier layer and an extrusion coated layer in the same coating line in accordance with the invention has shown to give rise to a packaging material with remarkably good barrier properties, especially gas-, liquid and/or grease barrier properties, for the packaging of food and/or liquid.

### FIELD OF THE INVENTION

The present invention relates to a process for producing a packaging material.

### BACKGROUND

Fiber based material used in packages or cups for liquid, dry or frozen food is usually provided with barrier coatings both on the inside (facing the packed item) and on the outside (print-side). The barrier coating applied on the inside makes the material resistant against e.g. liquids, grease, aroma and/or gas and enables it to withstand the influence of the packed item on the packing material. The barrier coating should also be heat-sealable. The barrier on the outside is applied to protect the packed item from the surrounding, especially from water vapor and condensation that is formed on the surface due to temperature fluctuations or temperature differences between cup outside vs cup inside (when filled).

Barriers are normally created by coating the fiber based substrate (the paperboard) with a composition which gives the substrate barrier properties. The most commonly used materials when forming a barrier on a fiber based product are polyolefins, such as polyethylene (PE) or polypropylene (PP), which usually are extrusion coated or laminated to the fiber based substrate. Today, also bio-based versions thereof are used including other bio-based polymers such as PLA. Extrusion coating is a continuous process by which a thermoplastic polymer such as a polyolefin is melted and extruded through a flat die onto a chill roll. The chill roll primarily acts as a heat transfer and finishing device in the extrusion and coating operations.

Liquid packaging board is usually provided with polymer coating on both sides and oftentimes with an additional aluminum coating layer on the inside. Paperboard intended for cups is oftentimes provided with a polyolefin coating to provide a barrier both on the inside towards the liquid content and on the outer/print side to provide a barrier against moisture arising from condensation.

Paperboard comprising extrusion coated or laminated polyolefin layers are however difficult to recycle and are usually not biodegradable or recyclable. The extrusion coated polymers are hard to disintegrate and re-use as part of a broke handling in paper and paperboard making. Legislations to ban the use of plastics are further discussed worldwide in order to reduce plastic waste.

In the prior art, dispersion barrier coatings have been proposed. One advantage oftentimes referred to in connection with dispersion coating is that it is possible to apply on-line in the paperboard machine. EP2358942 discloses a paperboard coated with a first and a second barrier coating layer consisting of an aqueous polymer dispersion comprising from about 70-90 wt % of a polymer emulsion and 10-30 wt % of a pigment. WO2015155413 discloses a coated food cardboard, with a dispersion barrier coating applied between the board layer and a pigment coating layer. WO9854410 discloses a coated board comprising a talc containing polymeric dispersion barrier layer. However, dispersion coatings are oftentimes not enough to provide the required barriers against liquid or food and to deliver a long ambient shelf life. WO2019239334 discloses a packaging material comprising barrier layer comprising a water-soluble polymer and an extrusion coated layer of a polyolefin on the barrier layer. The barrier layer comprising the water-soluble polymer is preferably applied on-line in the paperboard machine.

There remains a need for a process to produce a heat sealable fiber-based packaging material for liquid, frozen or dry food, which packaging material is repulpable with high yield and which still provides the required barrier properties for long ambient shelf life.

### SUMMARY OF THE INVENTION

In a first aspect, the invention discloses a method for producing a packaging material comprising the steps of:
providing a roll of a paperboard web, which web has first side and a second side,
unwinding said web from the first roll in an unwind station,
applying, in a first coating step, at least one first barrier layer and an optional second barrier layer on the first side, wherein said first and optional second barrier layer is a dispersion barrier layer or a barrier layer comprising a water-soluble polymer selected from the group of polyvinyl alcohol (PVOH), a copolymer of ethylene and polyvinyl alcohol, starch, carboxymethylcellulose in an amount of at least 50 wt % based on the dry weight of the barrier layer, wherein said paperboard web and said barrier layer form a barrier coated web,
at least partly drying said barrier coated web in a first drying step,
applying, in a second coating step, an extruded layer comprising a polyolefin on the first side of said partly dried barrier coated web by extrusion coating, forming a barrier coated paperboard, and
rewinding said barrier coated paperboard onto a second roll in a rewind station,
wherein said first and second coating step are applied integrated within the same coating line.

In the context of the application, “integrated within the same coating line” is meant to define that the coating steps are applied in the same process on the same coating machine, preferably an off-line coating machine, when the web is running between an unwind station and a rewind station. Thus, the web is not re-winded between the said unwind station and said rewind station. An off-line coating machine as used in this context is meant to define a coating machine that is separate from a paperboard machine.

The application of a first barrier layer and an extrusion coated layer in the same coating line in accordance with the invention has shown to give rise to a packaging material with remarkably good barrier properties, especially gas-, liquid and/or grease barrier properties, for the packaging of food and/or liquid. The process enables the extrusion of the polyolefin on a hot web, without the need of pre-heating the web, which improves the film-forming of both the barrier layer and the extrusion coated layer. In addition, the adhesion of the extruded layer is remarkably improved, even in embodiments wherein the coat-weight of extruded polymer layer is low. The process thus allows the manufacturing of packaging materials comprising very thin extrusion coated layers of polyolefin. The said process further improves the trans-crystalline structure formed at the interface between the polyolefin layer and the barrier layer, which further enhances the barrier properties. Moreover, the process realizes savings in both energy and materials.

In a second aspect, the invention discloses a heat-sealable packaging material made according to the method disclosed in accordance with the first aspect. The heat-sealable packaging material may be further characterized by the features defining the method according to the first aspect.

### DETAILED DESCRIPTION

“Paperboard web” as used herein refers to a web of a fiber-based substrate comprising cellulose fibers. A typical fiber-based substrate used for packaging material comprises at least one ply, preferably several plies. The fiber-based substrate may comprise bleached and/or unbleached fibers and it may be surface sized. The fiber-based substrate is preferably a multilayer packaging paperboard, comprising at least two plies, a back ply and a top ply. The fiber-based substrate may comprise for example a top and a back ply and at least one middle ply. The paperboard substrate may have a basis weight of at least 120 gsm, or at least 150 gsm, preferably at least 200 gsm. Such a multilayer paperboard substrate is particularly suitable for liquid and/or food packaging.

The gram mage or basis weight of a paperboard, substrate or coating layer refers to the weight expressed as grams per square meter, gsm or g/m². As used herein, gsm and g/m² may be used interchangeable.

If not specifically denoted otherwise, given % are weight %, and are calculated on the basis of a dry weight of 100 weight % of the respective object, such as a layer, ply or packaging.

As used herein, “dispersion barrier layer” refers to a layer that has been applied by dispersion coating onto the paperboard substrate, which provides a barrier against e.g. grease, gas or liquid. As used herein, “dispersion coating” refers to a coating technique where an aqueous dispersion of fine polymer particles is applied to the surface of a paper or paperboard to form a solid, substantially non-porous film after drying. The dispersion coating layers may be applied by the use of roller coating, spray coating, curtain, blade coating, slot coating, immersion coating, gravure roll coating, reverse direct gravure coating, rod coating, soft-tip blade coating, jet coating and/or combinations thereof. Preferred coating methods are blade coating and rod coating. Dispersion coatings can be recycled.

As used herein, “dispersion coated polyolefin” refers to polyolefin applied by dispersion coating.

As used herein “extruded layer” refers to a layer applied onto a substrate by extrusion coating.

The term “latex” as used herein refers to an aqueous suspension of polymer particles, which can be natural polymers, synthetic polymers, synthetic polymers derived from biomasses or combination thereof.

The water absorption rate as expressed herein is measured using COBB 600 in accordance with SCAN-P 12:64.

The Water Vapor Transfer Rate as expressed herein is measured in accordance with ASTM F1249 with Mocon instrument at a temperature of 23° C. and at 50% RH.

The oxygen transfer rate (OTR) as expressed herein is measured in accordance with ASTM D3985, at a temperature of 23° C. and at 50% relative humidity (RH).

The number of pinholes as expressed herein is measured in accordance with EN13676:2001. The measurement involves treating the packaging material with a coloring solution (e.g. dyestuff E131 Blue in ethanol) and inspecting the surface microscopically

The reject received from the repulping of the packaging material is determined according to PTS test method RH021/97.

The grease resistance of creased and folded packaging materials is measured in accordance with ASTM F119-82. Prior to the measurement, the material was creased (Morgana Docu-Crease 52) and folded by a 2.07 kg roller and exposed on the first barrier-coated side, to animal oil (chicken fat) at 60° C. The time required to show a visual change on a thin-layer chromotography plate with a 254 nm fluorescent indicator placed under the board (=break through time or failure time) were noted. The grease resistance defines the break through- or failure time.

The invention discloses a method for producing a packaging material and a packaging material suitable for packaging of food and/or liquid. In the method of the invention a first barrier layer, and an optional second barrier layer, is applied on a first side of a paperboard web. The thereby formed barrier coated web is at least partly dried in a first drying step, whereupon an extruded layer is applied onto the partly dried barrier coated web in a second coating step. In accordance with the invention, the first and second coating steps are applied integrated within the same coating line. The first side of the thereby formed barrier coated paperboard is preferably adapted to form the inside of a thereof made packaging. Thus, the extruded layer is preferably adapted to be in contact with the content of a thereof made packaging.

The said first and optional second barrier layer is a dispersion barrier layer or a barrier layer comprising a water-soluble polymer selected from the group of polyvinyl alcohol (PVOH), a copolymer of ethylene and polyvinyl alcohol, starch, carboxymethylcellulose in an amount of at least 50 wt % based on the dry weight of the barrier layer. The first barrier layer can be applied by any known coating methods including e.g. roller coating, curtain coating, blade coating, rod coating or jet coating. In preferred embodiments, the first barrier layer is applied by use of curtain coating, blade coating and/or rod coating. The first and optional second barrier layer is preferably applied on the web at a total coat weight of in a range from ≥5 to ≤40 gsm, preferably in a range from ≥10 to ≤30 gsm or from ≥10 to ≤20 gsm.

The barrier coated web is preferably dried to a solid content of at least 85-95 wt % in the said first drying step. In the first drying step the barrier coated web is preferably dried using conventional drying techniques using e.g. hot air, IR In embodiments, the first drying step includes heating of the web so that after the drying step the web has a temperature of at least 30° C., preferably at least 40° C. or at least 50 or at least 60° C. or at least 70° C. Preferably, the web runs directly to the second coating step from the first drying step so that the web, when entering the second coating step, has a temperature of at least 30° C., preferably at least 40° C. or at least 50° C. or at least 60° C. or at least 70° C. The following extrusion coating (second coating step) further involves heating of the web, whereby the curing of the first barrier layer is extended, which improves the film forming of the layer.

The web tension throughout the coating line is preferably between 0.5-2 kN/m, more preferably between 0.5-1.5 kN/m. The web tension as used herein defines the tension across the width of the web. The web tension at the upwinding of the web at the unwind station is preferably between 0.5-1 kN/m, while the web tension at the rewinding of the barrier coated paperboard in the rewind station is preferably between 1-1.5 kN/m. Since the web is not rewinded between said upwind station and rewind station, a substantial constant web tension is maintained throughout the coating line. In this way, shrinkage of the web between the first and optional second barrier layer and the application of the extruded layer is minimized, whereby the barrier properties of the barrier coated paperboard are further enhanced.

Preferably, the extruded layer is applied at a coat weight in a range from 1 gsm to ≤15 gsm, or in a range from ≥5 gsm to ≤10 gsm. The polyolefin of the extruded layer may be a thermoplastic polyolefin, such as polyethylene (PE), polypropylene (PP), cyclic olefin copolymer (COC), polymethylpentene (PMP), or mixtures thereof. In preferred embodiments, the polyolefin of the extruded layer is selected from the group of polyethylene and polypropylene. These provide particularly good barrier properties and allow good application by extrusion coating.

The extruded layer is applied in the second coating step by use of extrusion coating. Extrusion coating is a continuous process by which a thermoplastic polymer such as a polyolefin is melted and extruded through a flat die onto a chill roll. The chill roll primarily acts as a heat transfer and finishing device in the extrusion and coating operations. Preferably, the extrusion of the extruded layer is further performed at a specific melt temperature which has the polymer when leaving the extruder. In embodiments of the method, the extrusion of a polyolefine layer is performed at a temperature in a range of ≥300° C. to ≤330° C. and/or the extrusion of a polypropylene layer is performed at a temperature in a range of ≥295° C. to ≥320° C. In embodiments where

PE is used for the polyolefin layer, the melt temperature preferably is in a range of ≥310° C. to ≤325° C. and the chill roll temperature is preferably in a range of ≥10° C. to ≤25° C. In embodiments where PP is used for the polyolefin layer, the melt temperature preferably is in a range of ≥300° C. to ≤315° C. and the chill roll temperature is preferably in a range of ≥10° C. to ≤25° C.

Paperboard substrates are usually treated by corona, flame or ozone treatment prior to extrusion coating to improve the adhesion of the extruded layer. The process of the invention makes it possible to minimize such treatment and yet achieve good adhesion of the extruded polyolefin layer. In this way, problems with undesirable smell and/or taste are diminished. In embodiments, the web is not subjected to any corona, flame or ozone treatment prior to the second coating step.

The method may further comprise a step of applying moisture to the second side for curl control.

The process of the invention enables the use of thin layers of extrusion coated polyolefin and still achieve good barrier properties. In embodiments, the layer comprising a polyolefin is applied in the second coating step at a coat weight of less than 15 gsm, preferably less than 10 gsm, most preferably less than 7 gsm.

In embodiments, the second step of applying an extruded layer is the only extrusion coating step of the method and the method does not include any further steps of extrusion coating or laminating thermoplastic polymer layers on the web. Further preferred, the method does not comprise any step of applying layers or foils of aluminum. The said extruded layer is preferably adapted to form the inside of a thereof formed packaging and is thus adapted to be in contact with the content of such a formed packaging.

The weight of the extruded barrier layer may further depend on the basis weight of the paperboard substrate. In embodiments, the paperboard substrate may have a low grammage in a range from 150-230 gsm, wherein the extruded layer may be applied at a grammage in a range from 1.5-11 gsm or 1.5-5 gsm, or 5-11 gsm. In embodiments, the paperboard substrate may have a grammage above 230 gsm, such as in a range of 230-400 gsm or from 200-360 gsm. In these embodiments, the extruded may be applied at a gram mage in a range of from 2-15 gsm or 10-15 gsm or 5-11 gsm.

In embodiments, the second coating step may further comprise the application of a second extruded layer comprising a polyolefin, so that the web comprises a first and a second extruded layer, wherein said second extruded layer is extruded onto said first extruded layer. Preferably, the first and the second extruded layer are applied on the first side at coat weights so that the sum of the first extruded layer and the second extruded layer is less than 15 gsm, preferably less than 10 or less than 7 gsm. In these embodiments, the application of said first extruded layer and said second extruded layer preferably constitutes the only application of extrusion coated or laminated thermoplastic polymer layers of the packaging material and the method does not include the application of any further extrusion coated or laminated thermoplastic polymer layers. Further preferred, the method does not comprise the application of a layer or foil of aluminum on the packaging material. In embodiments, said first and second extruded layer may be applied to the paperboard substrate by use of co-extrusion. The said second extruded layer is preferably adapted to form the inside of a thereof formed packaging and is thus adapted to be in contact with the content of such a formed packaging.

In embodiments, the first and optional second barrier layer is a dispersion barrier layer comprising a latex and optional pigment and/or a polyolefin. Preferably the first and optional second barrier layer comprise the latex and/or polyolefin in an amount of at least 30 wt %, such as in a range of from ≥30 wt % to ≤100 wt %, or in a range of from ≥30 wt % to ≤70 wt %, calculated of the total solid content of the layer. The latex may be selected from the group comprising styrene-butadiene latex, styrene-acrylate latex, acrylate latex, vinyl-acetate latex, acrylate latex, vinyl acetate latex, vinyl acetate-acrylate latex, styrene-butadiene-acrylonitrile latex, styrene-acrylate-acrylonitrile latex, styrene-butadiene-acrylate-acrylonitrile latex, styrene-maleic anhydride latex, styrene-acrylate-maleic anhydride latex, or mixture of these latexes. The latex is preferably a styrene-butadiene (SB) latex or a styrene-acrylate (SA) latex, acrylate latex, vinyl acetate latex, or vinyl acetat-acrylate latex, or mixture of these latexes. The latex can be biobased, i.e. derived from biomass, such as biobased styrene-acrylate or styrene-butadiene latex. Biobased latex can provide similar performance and provides improved carbon footprint.

The first and/or second barrier layer may further comprise pigments, such a pigment selected from the group of clay (preferably kaolin clay), calcium carbonate and/or talc.

In addition to latex and pigments, the barrier layer or layers may further comprise a small amount of additives, such as between 0.1-5 wt %, or 0.1-1, or 1-5 wt %, as calculated on the dry weight of said dispersion coating layer. Additives may include thickening agents, defoaming or antifoaming agents, dispersing aids, additional pigments, cross-linkers, slip additives, fillers, release agents, preservatives and antiblocking agents.

In accordance with one embodiment of the invention, the at least one barrier layer comprises a cross-linker. Cross-linker as used herein is meant to define an agent that reacts with carboxyl- and/or hydroxyl groups. The cross-linker is preferably chosen from the group of Ammonium Zirconium Carbonate (AZC), Potassium Zirconium Carbonate, Potassium Zirconium Acetate (Methylated) melamine formaldehyde resin or (methylated) urea formaldehyde resin, Glyoxal, Imidazoline derivatives, di-aldehyde polysaccharides, citric acid and combinations thereof. The cross-linker is preferably added in an amount of between 0.1-5 wt %, or between 1-2 wt % as calculated on the dry weight of said dispersion coating layer. The cross-linker further improves the barrier properties e.g. by providing a denser and less porous coating layer. In addition, the smoothness of the surface is improved. In one preferred embodiment, the cross linker is chosen from the group of di-aldehyde polysacchardies such as dialdehyde cellulose (DAC) and di-aldehyde starch.

In embodiments, the barrier layer comprises a water-soluble polymer selected from the group of polyvinyl alcohol (PVOH), a copolymer of ethylene and polyvinyl alcohol, starch, carboxymethylcellulose in an amount of at least 50 wt % based on the dry weight of the barrier layer.

In embodiments, the barrier layer comprises the water-soluble polymer in an amount in a range of ≥50 weight % to ≥100 weight %, preferably in a range of ≥70 weight % to ≤95 weight %, more preferably in a range of ≥80 weight % to ≤90 weight %, based on the dry weight of the barrier layer.

In embodiments, the water-soluble polymer of the barrier layer is PVOH or a copolymer of ethylene and PVOH. A copolymer of ethylene and PVOH may be preferred, which provides a better moisture resistance. In embodiments wherein the water-soluble polymer is PVOH or a copolymer of ethylene and PVOH, the grammage of the layer or layers preferably is in a range from ≥4 g/m2 to ≤6 g/m2.

In a further embodiment, the water-soluble polymer of the barrier layer is starch. The starch is preferably an amylopectin-rich starch, preferably comprising more than 99% amylopectin. This provides improved film forming. In embodiments wherein the water-soluble polymer is starch, the grammage preferably is in a range from ≥5 g/m2 to ≤10 g/m2.

In a further embodiment, the water-soluble polymer of the barrier layer is carboxymethylcellulose. In embodiments wherein the water-based polymer is CMC, the grammage of the layer is in a range from ≥4 g/m2 to ≤6 g/m2.

In a further embodiment, the first and optional second barrier layer or layers further comprises pigments, such as a pigment selected from the group of clay, calcium carbonate, talc and/or nanopigments. Preferably, the clay is kaolin clay. The term nanopigments refers to nanoscale powders. Pigments may further improve the barrier properties. The barrier layer may comprise pigments in an amount of less than 50 weight %, based on the dry weight of the barrier layer.

Nano pigments as used herein is meant to define pigments, wherein 90 wt % of the pigments have an average pigment particle size d₅₀ is less than 100 nm. The d₅₀ is defined as the median particle size value at the 5th percentile of the particle size distribution, wherein 50% of the particles in the distribution are greater than the d₅₀ particle size value and the other 50% of the particles in the distribution are less than the d₅₀ value. Average particle size can be estimated by using light scattering methods to infer particle size, such as Dynamic light scattering.

In embodiments, the barrier layer may comprise at least 50 weight %, 80 weight % or 90 weight % of a water-soluble polymer selected from the group of PVOH, copolymer of ethylene and PVOH, starch and/or CMC, in a range from ≥0 weight % to ≤50 weight % of an additive selected from the group of maleic acid copolymers and/or acrylic acid copolymers, and in a range from ≥0 weight % to ≤10 weight % of a second additive such as a de-foamer or a rheology modifier, the weight % based on a total dry weight of 100 weight % of the barrier layer.

The first coating step of the inventive method may further comprise the application of a second barrier layer on the first barrier layer, said second barrier layer being a dispersion barrier layer or a barrier layer comprising a water-soluble polymer selected from the group of polyvinyl alcohol (PVOH), a copolymer of ethylene and polyvinyl alcohol, starch, hydroxypropylated starch carboxymethylcellulose in an amount of at least 50 wt % based on the dry weight of the barrier layer. Said second barrier layer can be of the same composition as the first barrier layer, or a different composition. In said embodiments, the method preferably comprises an in-between drying step of drying the first dispersion barrier layer prior to the application of the second dispersion barrier layer, forming the barrier coated web.

In one embodiment, the method involves applying a first barrier layer, which first barrier layer comprises pigment in an amount in a range from ≥30 wt % to ≤70 wt %. The application of a barrier layer comprises pigments in the first layer, followed by additional barrier layers, contribute to diminish the transfer of heat from the drying step into the paperboard web. In this way, the coatings keep the high temperature also throughout the second coating step, which enhances the film formation.

In embodiments, the method may further comprise applying, in a third coating step, at least one third barrier layer and an optional fourth barrier layer on the second side, wherein said third and optional fourth barrier layer is a dispersion barrier layer or a barrier layer comprising and an optional second barrier layer on the first side, wherein said third and optional fourth barrier layer is a dispersion barrier layer or a barrier layer comprising a water-soluble polymer selected from the group of polyvinyl alcohol (PVOH), a copolymer of ethylene and polyvinyl alcohol, starch, carboxymethylcellulose in an amount of at least 50 wt % based on the dry weight of the barrier layer forming a second barrier coated web, and drying, in a second drying step the said formed second barrier coated web. In these embodiments, said first, second and third coating step are applied integrated within the same coating line.

These third and optional fourth barrier layers may have the same composition as the first and optional third barrier layers and may thus also comprise latex or polyolefin and optional pigment, such as latex and pigment or polyolefin and pigment, or a water-soluble polymer chosen from the group mentioned above. The said third and optional fourth barrier layer/s may constitute the only barrier layer on the second side. Said second side may in this embodiment form a printing surface and, in such embodiment, said barrier layer/s particularly form a barrier against moisture arising from condensation.

In embodiments, the method may further comprise the steps of applying, in a fourth coating step a third extruded layer comprising a polyolefin on said second partly dried barrier coated web by extrusion coating, wherein said first, second, third and fourth coating step are applied integrated within the same coating line. Preferably, the third extruded layer comprising polyolefin is applied in the fourth coating step at a coat weight of less than 15 gsm, preferably less than 10 gsm, most preferably less than 7 gsm. The fourth coating step may further comprise the application of a fourth extruded layer comprising a polymer on the third extruded layer, e.g. by co-extrusion. In one preferred embodiment, the first, optional second, the third and optional fourth extruded layers are applied at a total coat weight of less than 15 gsm. Thus, the method preferably involves the extrusion of extruded polyolefin layers on the web at a total coat weight of less than 15 gsm. Thus, the method preferably does not comprise any step of laminating further thermoplastic polymer layers or the application of a layer or foil of aluminum.

The invention further discloses packaging material made according to the method herein disclosed. The packaging material made according to the inventive method exhibits excellent barrier properties, although it comprises such low amount of extruded plastic layers. The packaging material of the invention may exhibit a water absorption rate of below 15 g/m2, preferably of below 13 g/m2 and most preferably below 10 g/m2 a as measured using COBB 600 in accordance with SCAN-P 12:64 and/or a Water Vapor Transfer Rate (WVTR) of less than 15 g/m2/24h, preferably less than 10, or 5 g/m2/24h as measured using ASTM F1249. It may further exhibit an oxygen transfer rate (OTR) of below 50 cc/m2*day*atm, preferably below 20 cc/m2, or even below 10 cc/m2, as measured according to ASTM D3985, 23° C., 50% A relative humidity (RH). The present invention has further surprisingly shown that pinholes can be diminished or avoided even with low weights of extrusion coated layers. The packaging material may further comprise less than 10 pinholes/m², preferably 0 pinholes/m² as measured according to standard EN13676:2001.

The packaging material of the invention is further easily repulpable. The reject received from the repulping of the packaging material (determined according to PTS test method RH021/97) is preferably less than 20 wt % preferably less than 15 wt %, more preferably less than 10 wt %, based on a dry weight of the packaging material of 100 wt %.

The packaging material of the invention has further shown to exhibit excellent barrier properties also when folded and creased. The grease resistance of the packaging material as creased and folded is preferably at least 20h, preferably at least 25h, according to ASTM F119-82 (60° C., 0% RH).

A packaging made from the packaging material of the invention is particularly suitable for packaging of food and/or liquids. It may further be retortable.

Further features of the present invention will become apparent from the examples and figures, wherein:

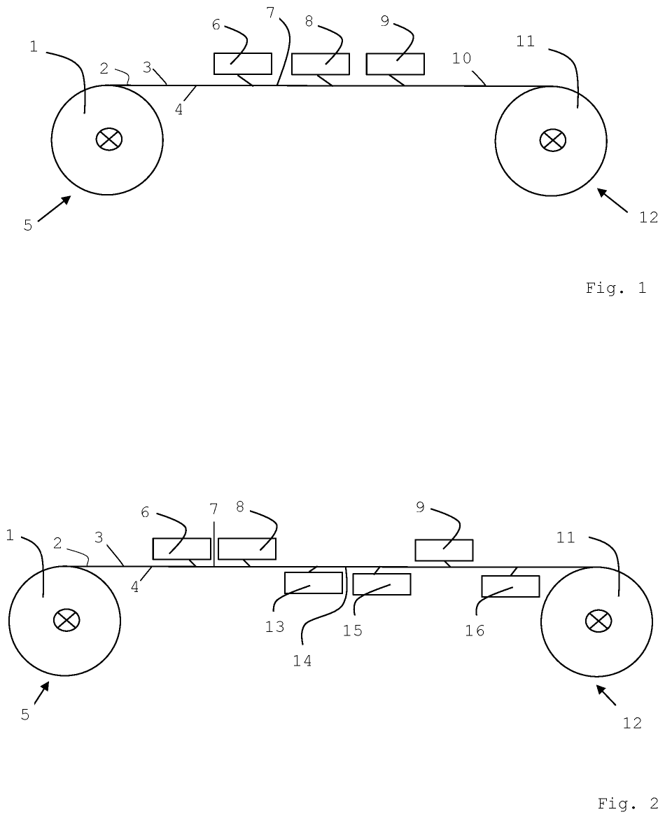

FIG. 1 is a schematic drawing of a coating line according to one embodiment of the invention.

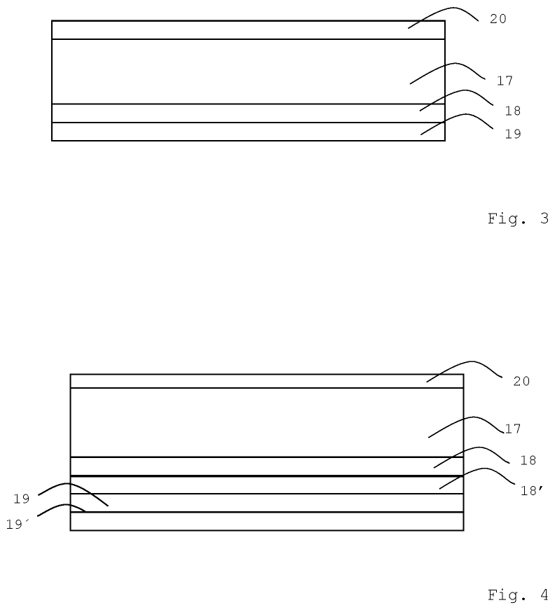

FIG. 2. Is a schematic drawing of a coating line according to a further embodiment of the invention.

FIG. 3 is schematic drawing of a packaging material according to an embodiment of the invention.

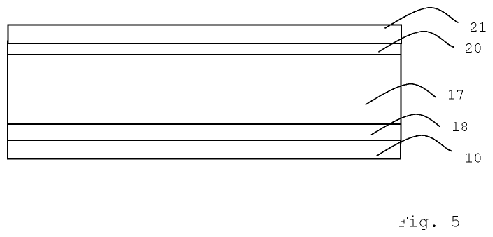

FIG. 4 is a schematic drawing of a packaging material according to a further embodiment of the invention.

FIG. 5 is a schematic drawing of a packaging material according to a further embodiment of the invention.

In the embodiment shown in FIG. 1 the web (2), having a first side (3) and a second side (4), is rewinded from a first roll (1) in an unwind station (5). Thereafter, the web is drawn to a first coating step (6) wherein a first barrier layer is coated onto the first side (3) of the web, e.g. by rod or blade coating, forming a barrier coated web (7). The first coating step (6) can in embodiments further comprise the application of further barrier layers, such as a second barrier layer. In such embodiments, the coating step (6) includes an in-between drying step to dry the web in-between the application of the barrier layers. After the first coating step (6) the barrier coated web (7) is dried in a first drying step (8), preferably to a web temperature of around 30-70° C., preferably to a web temperature of around 50-70° C. After the first drying step (8), the partly dried barrier coated web (7) is directly drawn to a second coating step (9) wherein an extruded layer is applied onto the barrier coated web (7) by extrusion coating. The web may have a temperature of around 40° C. or around 50° C. when entering into the second coating step (9). The method may comprise further drying steps (not shown) after the extrusion coating, prior to the web being rewinded onto a second roll (11) in a rewind station (12).

In the embodiment shown in FIG. 2, the web (2) is first coated with at least a first barrier layer on the first side (3) in the first coating step (6), whereupon the thereof formed barrier coated web (7) is dried in the first drying step (8). Thereafter, a barrier layer is applied on the second side (4) of the web in a third coating step (13). The thereby formed second barrier coated web (14) is dried in a second drying step (15). The partly dried second barrier coated web (14) is thereafter applied with an extruded layer on the first side (2) in the second coating step (9) and then with an extruded layer on the second side (4) in a fourth coating step (16). The thereby formed barrier coated paperboard may be further dried before being rewinded onto the second roll (11) in the rewind station (12).

The packaging material shown in FIG. 3 comprises a fiber-based substrate (17). The fiber-based substrate has a first and a second side, wherein on the first side the paperboard substrate is coated with a first barrier layer (18) providing a barrier against liquid, moisture, grease and/or gas.

An extruded layer of polyolefin (19), such as of polyethylene or polypropylene, is extrusion coated on the first barrier layer (18). The extruded layer (19) will in this embodiment be in contact with the content of a packaging formed from the packaging material. The second side of the paperboard substrate 1 is coated with another (third) barrier layer (20), wherein the barrier layer (20) forms the printing surface of the packaging material. In this embodiment, the coat weight of the extruded layer (19) is preferably less than 15 gsm, preferably less than 10 gsm or less than 7 gsm.

The packaging material shown in FIG. 4 comprises a fiber-based substrate 17. The fiber-based substrate has a first and a second side, wherein on the first side the fiber-based substrate is coated with a first and a second barrier layer (18, 18′). A first and a second extruded layer of polyolefin (19, 19′) is extrusion coated on the second barrier layer (18′). The second extruded layer (19′) will be in contact with the content of the packaging formed from the packaging material. The second side of the fiber-based substrate (17) is coated with a third barrier layer (20). In this embodiment, the sum of the coat weight of the first and second extruded layer of polyolefin (19, 19′) is preferably less than 15 gsm, or less than 10 gsm or less than 7 gsm.

The packaging material shown in FIG. 5 comprises a fiber based substrate (17) having a first and a second side, wherein the fiber-based substrate is coated with a first barrier layer (18) and a first extruded layer of a polyolefin (19) on its first side and a third barrier layer (20) and a third extruded layer of a polyolefin (21) on its second side. In this embodiment, the sum of the coat weight of the first and third extruded layer of polyolefin (19, 21) is preferably less than 15 gsm, or less than 10 gsm or less than 7 gsm.

1. A method for producing a packaging material comprising the steps of:
providing a first roll of a paperboard web, wherein the paperboard web has a first side and a second side,
unwinding said paperboard web from the first roll in an unwind station,
applying, in a first coating step, at least one first barrier layer on the first side, wherein said first barrier layer is a dispersion barrier layer or a barrier layer comprising a water-soluble polymer selected from a group consisting of: polyvinyl alcohol (PVOH), a copolymer of ethylene and polyvinyl alcohol, starch, and carboxymethylcellulose, in an amount of at least 50 wt % based on a dry weight of at least one first barrier layer, wherein said paperboard web and said at least one first barrier layer form a barrier coated web;
drying said barrier coated web in a first drying step,
applying, in a second coating step, an extruded layer comprising a polyolefin on the first side of said dried barrier coated web by extrusion coating, and thereby forming a barrier coated paperboard, and
rewinding said barrier coated paperboard onto a second roll in a rewind station,
wherein said first and second coating step are applied integrated within a same coating line.

2. The method according to claim 1, wherein the first drying step includes heating of the barrier coated web so that after the drying step the barrier coated web has a temperature of at least 30° C.

3. The method according to claim 1, wherein a tension of the paperboard web throughout the coating line is between 0.5-2 kN/m.

4. The method according to claim 1, wherein the barrier coated web is not subjected to corona, flame or ozone treatment prior to the second coating step.

5. The method according to claim 1, wherein the extruded layer is applied at a coat weight of less than 15 gsm.

6. The method according to claim 1, wherein the said extruded layer forms a first extruded layer and wherein the second coating step further comprises the step of:
applying second extruded layer comprising a polyolefin on the first extruded layer by extrusion coating.

7. The method according to claim 1, wherein the first barrier layer is a dispersion barrier layer and wherein said dispersion barrier layer comprises a latex, or a polyolefin, or both.

8. The method according to claim 1, wherein the first barrier layer comprises a water-soluble polymer selected from a group consisting of: polyvinyl alcohol (PVOH), a copolymer of ethylene and polyvinyl alcohol, starch, and carboxymethylcellulose, in an amount of at least 50 wt % based on a dry weight of the first barrier layer.

9. The method according to claim 1, wherein the first coating step includes the application of a second barrier layer on the first barrier layer, said second barrier layer comprises a dispersion barrier layer or a barrier layer comprising a water-soluble polymer selected from a group of polyvinyl alcohol (PVOH), a copolymer of ethylene and polyvinyl alcohol, starch, and carboxymethylcellulose, in an amount of at least 50 wt % based on the dry weight of the second barrier layer.

10. The method according to claim 9, wherein the first barrier layer further comprises a pigment in an amount in a range from ≥30 wt % to ≤70 wt %.

11. The method according to claim 1, wherein the method further comprises the steps of:
applying, in a third coating step at least one barrier layer on the second side, wherein said barrier layer applied on the second side is a dispersion barrier layer or a barrier layer water-soluble polymer selected from a group consisting of; polyvinyl alcohol (PVOH), a copolymer of ethylene and polyvinyl alcohol, starch, and carboxymethylcellulose, in an amount of at least 50 wt % based on the dry weight of the at least one barrier layer on the second side, thereby forming a second barrier coated web 14, and
drying, in a second drying step second barrier coated web,
wherein said first, second, and third coating step, are applied integrated within the same coating line.

12. The method according to claim 11, wherein the method further comprises the steps of:
applying, in a fourth coating step a third extruded layer comprising a polyolefin on the second side of said second barrier coated web by extrusion coating, wherein said first, second, third and fourth coating step are applied integrated within the same coating line.

13. The method according to claim 1, wherein the method comprises application of extruded layers comprising a polyolefin on the web at a total coat weight of less than 15 gsm.

14. A heat-sealable packaging material made according to the method as claimed in claim 1.

15. The heat-sealable packaging material according to claim 14, wherein the heat-sealable packaging material exhibits a water absorption rate of below 15 g/m² as measured using COBB 600 in accordance with SCAN-P 12:64, a Water Vapor Transfer Rate (WVTR) of less than 15 g/m²/24h as measured using ASTM F1249, or both.

16. The heat-sealable packaging material according to claim 14, wherein the heat-sealable packaging material exhibits an oxygen transfer rate (OTR) of below 50 cc/m²*day*atm as measured according to ASTM D3985, 23° C., 50% relative humidity (RH).

17. The heat-sealable packaging material according to claim 14, wherein the heat-able packaging material comprises less than 10 pinholes/m² as measured according to standard EN13676:2001.

18. The heat-sealable packaging material according to claim 14, wherein a reject received from a re-pulping of the heat-sealable packaging material (determined according to PTS test method RH021/97) is less than 20 wt % based on a dry weight of the heat-sealable packaging material of 100 weight %.

19. The heat-sealable packaging material according to claim 14, wherein a grease resistance of a folded and creased material is at least 20 h according to ASTM F119-82 (60° C.).
